(19) United States
(12) Patent Application Publication
(10) Pub. No.: US 2015/0217470 A1
(43) Pub. Date: Aug. 6, 2015

(54) NOVEL SLICING GUIDE APPARATUS AND METHODS OF USING THE SAME

(71) Applicant: Frederick Anthony Lowetz, Weatherford, TX (US)

(72) Inventor: Frederick Anthony Lowetz, Weatherford, TX (US)

(21) Appl. No.: 14/262,776

(22) Filed: Apr. 27, 2014

Related U.S. Application Data
(60) Provisional application No. 61/934,691, filed on Jan. 31, 2014.

(51) Int. Cl. B26B 29/06

(52) U.S. Cl. CPC B26B 29/063

(57) ABSTRACT

In preferred embodiments, the present disclosure provides a novel slicing guide apparatus comprising in some examples: a cylindrical wall configured to create and receive perishable food items comprising a top and base; a first set of parallel pairs of vertical slots, wherein the slots extend from the base to below the top of the wall; and a second set of parallel pairs of vertical slots positioned perpendicular to the first set of pairs of vertical slots, wherein the slots extend from the base to below the top of the wall.

### CROSS REFERENCE TO RELATED APPLICATION

The present application claims priority to, co-pending U.S. provisional patent application No. 61/934,691 filed Jan. 31, 2014, and entitled “LETTUCE SLICING GUIDE”. The entire contents of the above-referenced patent application are incorporated by reference herein.

### FIELD OF THE INVENTION

The present invention relates to the field of processing foods for consumption, and more particularly, to slicing guides and apparatuses for reducing perishable foods into small, bite-sized pieces.

### BACKGROUND

Current domestic methods of processing lettuce for human consumption include tearing the lettuce leaves to size by hand or slicing the leaves free-handedly to size on a cutting board. These approaches are laborious, time consuming, and messy. Additionally, slicing the leaves free-handedly to size on a cutting board may result in accidental cutting of the preparer's fingers and/or hands. Furthermore, unless a great amount of skill and effort is applied to the process, these methods typically fail to yield pieces of lettuce of the desired size. Therefore, for the average consumer of lettuce, processing the lettuce is a troublesome, frustrating, and tedious endeavor.

Lettuce cutting devices have been developed that comprise a grid of intersecting blades which are simultaneously pressed through a half, or even a whole head, of lettuce. Half-head slicing devices designed to be affordable to the domestic consumer are of very delicate construction and won't hold up to much use. Whole-head devices are designed for high volume commercial use and are unaffordable to the domestic user. Both are also difficult to clean, and the multi-blade sets must be disposed of and replaced when they become loose or dull and they are expensive. The whole-head devices also require a significant amount of storage space when not in use.

Therefore, a need exists for a novel slicing guide apparatus for domestic use that can reduce perishable food items, such as lettuce, into bite-sized pieces. There is a further need for a lettuce slicing apparatus that is simple to operate, safe, and an affordable alternative to a restaurant-grade lettuce cutting machine, requiring very little space to operate and store. There also exists a need for a lettuce slicing apparatus that provides for easy clean-up, and should comprise a durable design that will last a long time under normal use. Finally, there exists a need for a lettuce slicing apparatus that is able to utilize a low-cost cutting utensil that is replaceable without the need to disassemble or service the apparatus.

### BRIEF SUMMARY OF THE INVENTION

It is one object of the present invention to provide novel slicing guide apparatuses and methods that can reduce lettuce, in addition to other perishable and non-perishable food items, into smaller units such as into bite-sized pieces.

Another object of the present invention is to provide a slicing guide apparatus that is simple to operate, safe, and an affordable alternative to both very-delicate domestic half-head and rugged restaurant-grade whole-head lettuce cutting machines, requiring very little space to operate and store.

An additional object of the present invention is to provide a slicing guide apparatus that provides for easy clean-up, and should comprise a durable design that will last a long time under normal use.

A further object of the present invention is to provide a slicing guide apparatus that is able to utilize a low-cost cutting utensil that is replaceable without the need to disassemble or service the apparatus.

In preferred embodiments, the apparatus comprises a generally hollow cylindrical container, configured to receive perishable food items such as lettuce as well as other foods. The apparatus generally comprising an open top end and a base end which may preferably be an open base end; a first set of pairs of vertical slots, wherein the slots extend from the base to below the top of the wall; a second set of pairs of vertical slots positioned perpendicular to the first set of pairs of vertical slots, wherein the slots extend from the base to below the top of the wall. In preferred embodiments, the operating method generally comprises; placing the slicing guide apparatus atop a cutting board; placing lettuce or other food item into the interior of the apparatus and downward atop the cutting board; inserting the blade of a cutting utensil into a pair of slots above the food; passing the blade of the cutting utensil down through the slots and through the food item; removing the blade of the cutting utensil from the slots and the food item, and repeating the above processes until the blade has been passed through each slot to completely slice-up the food item.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a top perspective view of an example of a slicing guide apparatus according to various embodiments described herein.

FIG. 2 illustrates an elevation view of the front side of an example of a slicing guide apparatus according to various embodiments described herein.

FIG. 3A shows a plan view from the bottom of an example of a slicing guide apparatus according to various embodiments described herein.

FIG. 3B shows a plan sectional view from the top of an example of a slicing guide apparatus along the sectional line 3B of FIG. 2 according to various embodiments described herein.

FIG. 4 depicts a top perspective view of an example of a slicing guide apparatus in use according to various embodiments described herein.

FIG. 5 depicts an example methodology of reducing the size of perishable food items according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New slicing guide apparatuses and methods of using slicing guide apparatuses are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

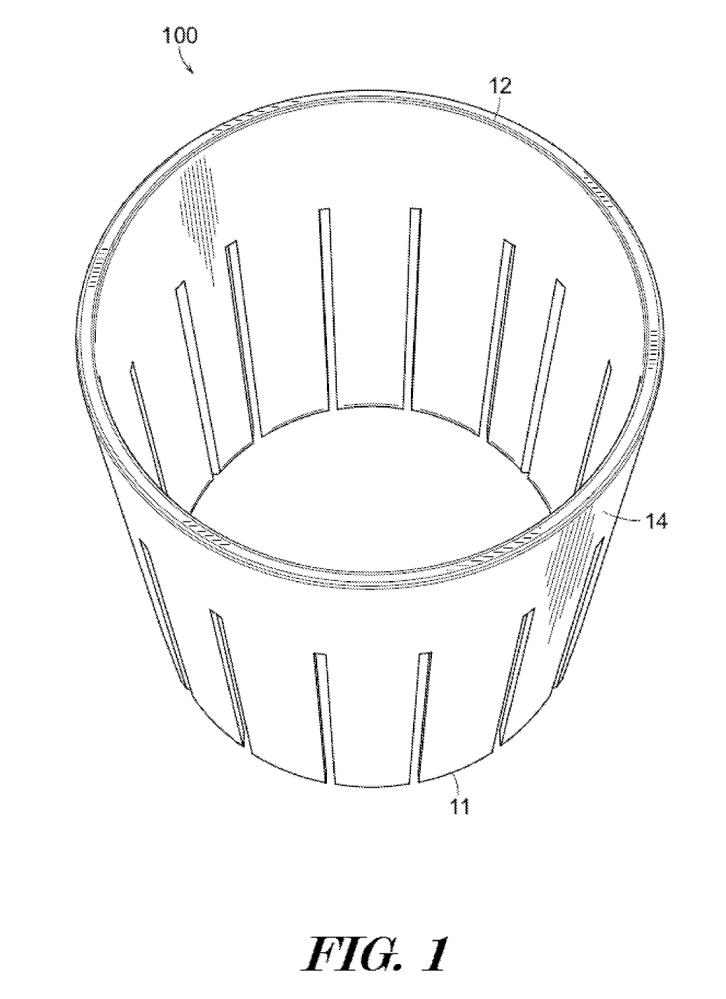

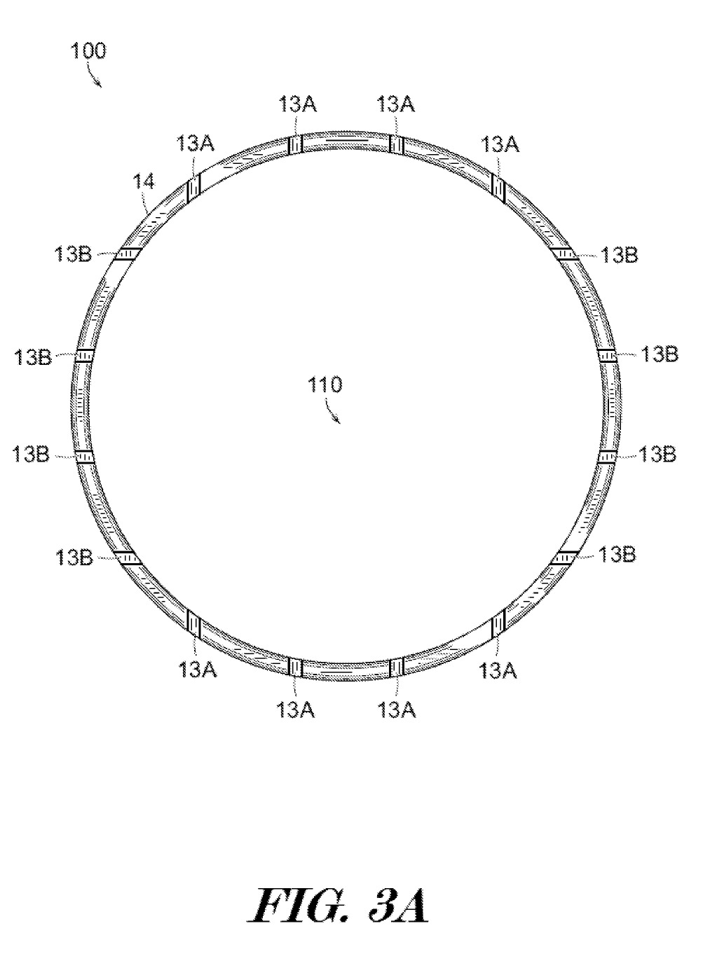

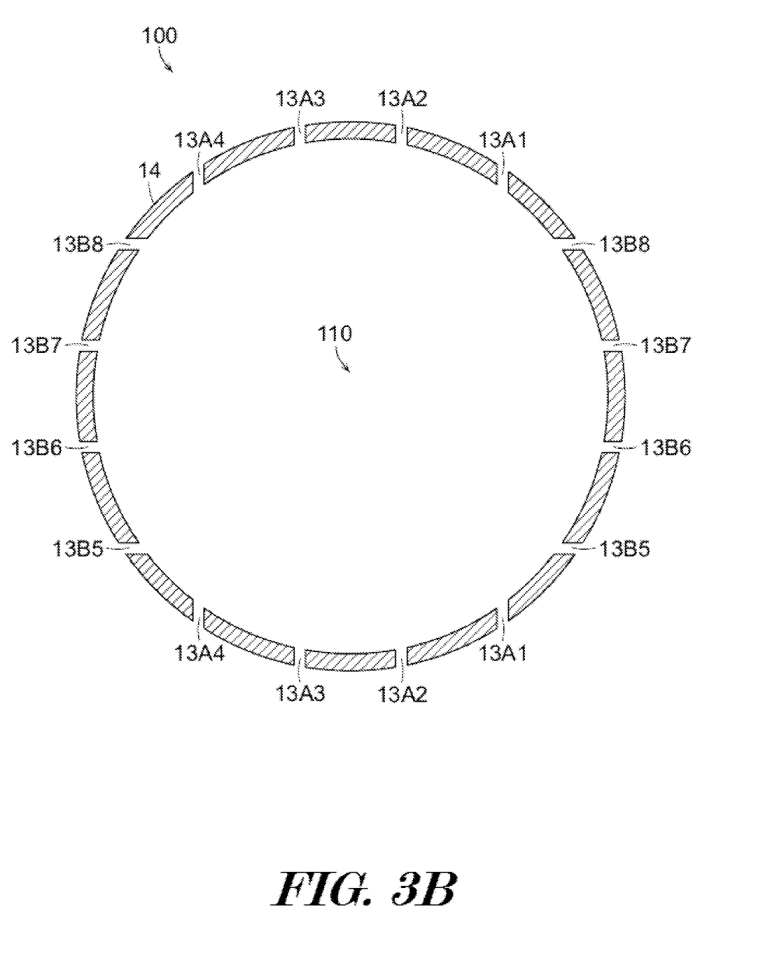

The present invention will now be described by example and through referencing the appended figures representing preferred and alternative embodiments. FIG. 1 illustrates an example of a slicing guide apparatus (“the apparatus”) 100 according to various embodiments. In this example, the apparatus 100 comprises a hollow cylindrical shaped device with a food receiving cavity 110 (FIG. 3B) which is unbounded and open at the top 12, upper terminal plane, and is unbounded and open at the base 11, lower terminal plane, which are both perpendicular to the central axis surrounded by the side wall 14 of the apparatus 100. In other embodiments, the apparatus 100 may be constructed in a plurality of geometric and non-geometric shapes including; rectangular prism, cube, triangular prism, hexagonal prism, tetrahedron, square pyramid, cone, sphere, or any other 3D geometric shapes including combinations of shapes.

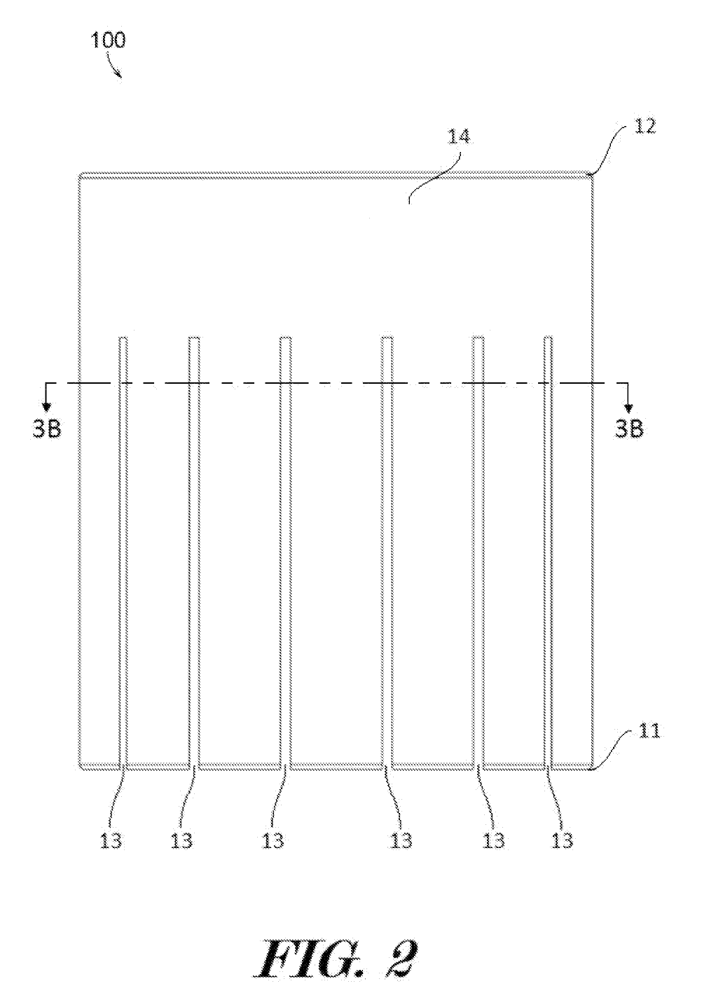

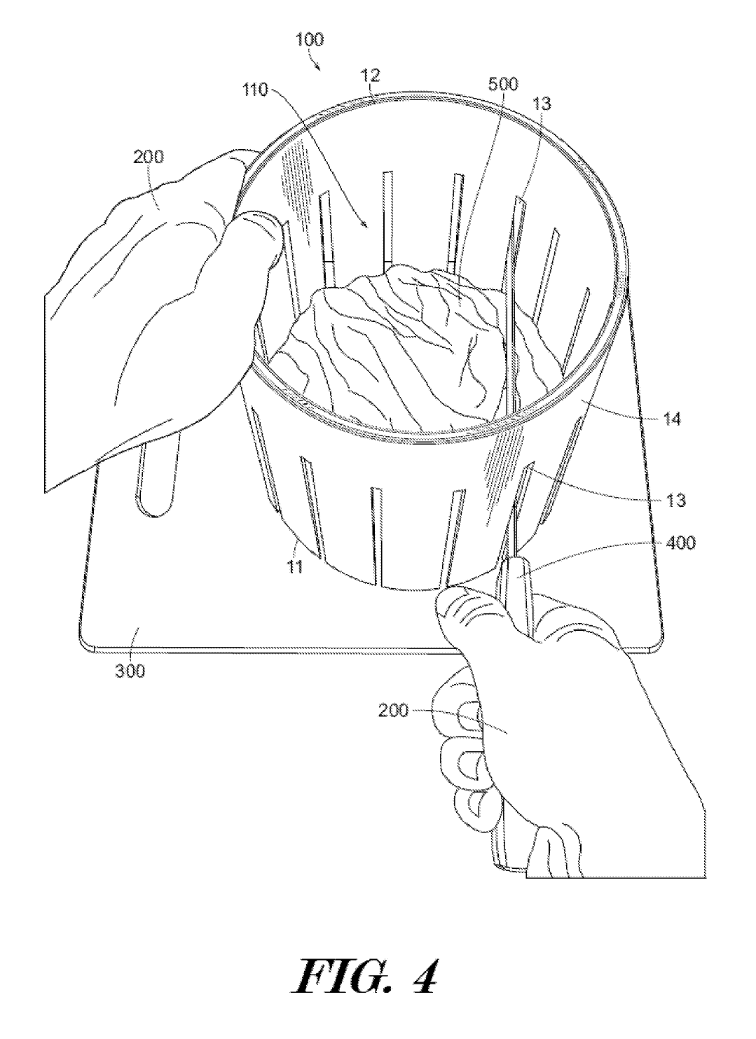

FIG. 2 illustrates an elevation view of the front side of an example of a slicing guide apparatus 100 according to various embodiments. In this illustration, six elongated slots 13 (the “elongate slot(s)”) can be seen on the wall 14 configured to guide the vertical motion of cutting utensils 400 (FIG. 4) comprising a blade. The apparatus 100 comprises a plurality of slots 13 which generally extend through the wall 14 from the base 11 and terminate below the top 12. The slots 13 are configured to be slightly larger in width than the width of the blade of common cutting utensils 400 (FIG. 4) to provide some freedom of movement of a blade of a cutting utensil 400 (FIG. 4) moving in a slot 13 but not so wide as to significantly alter the angle of the blade relative to the item of food within the apparatus 100.

Referring now to FIGS. 3A and 3B, in preferred embodiments, the slots 13 are arranged in opposing pairs comprising two slots 13 positioned opposite to each other around the side wall 14 of the apparatus 100. Also in preferred embodiments, the apparatus 100 comprises one set of pairs of slots 13 and a second set of pairs of slots 13 oriented perpendicular to the first set of pairs of slots 13. In some embodiments, a set of slots 13 may comprise eight slots 13 resulting in a set of four pairs. In other embodiments, a set of slots 13 may comprise ten slots 13 resulting in a set of five pairs. In further embodiments, a set of slots 13 may comprise between two slots (i.e. one pair) and sixteen slots 13 (i.e. eight pairs), or any suitable number of slots 13, pairs, or sets may be used.

FIG. 3A shows a plan view of the bottom of an example of a slicing guide apparatus 100 according to various embodiments. Here, the bottom of the apparatus 100 is open ended and forms the circular base of the cylindrical side wall 14. In this example, the apparatus 100 comprises two sets of four pairs of slots 13 (sixteen slots total). As shown in this embodiment, one set of four pairs of slots 13 (labeled as slot pairs 13A) is oriented to be perpendicular to the other set of four pairs of slots 13 (labeled as slot pairs 13B). The slots of one set of pairs 13A are oriented to be parallel to each other and also perpendicular to the slots of the other set of parallel slot pairs 13B. In other alternative embodiments, the slots 13 may be oriented other directions and configurations. In further embodiments, the pairs of slots 13 may be oriented to intersect with the central axis of the apparatus 100. In still further embodiments, the slots 13 may not be oriented in pairs or comprise an identifiable orientation, but simply allow access through the wall 14.

FIG. 3B shows a plan sectional view from the top of an example of a slicing guide apparatus 100 along the sectional line 3B of FIG. 2 according to various embodiments. In this example, the apparatus 100 comprises two sets of four pairs of slots 13. As shown in this embodiment, one set of four slot pairs 13A is oriented to be perpendicular to the other set of four slot pairs 13B. The slots of one set of pairs 13A are oriented to be parallel to each other and also perpendicular to the slots of the other set of parallel slot pairs 13B. Also depicted in this figure is an optional method of labeling the slots 13. The slots 13 may be labeled consecutively to aid in user selection by each pair being labeled with successive indicia so that, in some embodiments, a user may sequentially insert the blade of a cutting utensil 400 (FIG. 4) into and cut from slots 13A1-13A1, to 13A2-13A2, to 13A3-13A3, to 13A4-13A4, and upon rotating the apparatus counterclockwise approximately ninety degrees, recommence to cutting from 13B5-13B5, to 13B6-13B6, to 13B7-13B7, and to 13B8-13B8 in some embodiments where the apparatus 100 comprise two sets of four pairs of slots 13. The indicia may preferably be located on the outer side of the walls 14 but may additionally be located on the inner side of the wall 14 facing the food receiving cavity 110. Some non-limiting examples of indicia may be numeric indicia (1, 2, 3, 4, 5, etc.) or the indicia may be letters (A, B, C, D, E, etc.), or even alphanumeric combinations.

As perhaps best shown by FIG. 3B, each slot 13 is optimally angled or oriented to create a cutting channel aligned with an opposite and opposing slot 13 that is also angled and oriented to form each slot pair (e.g. slot pair 13A1-13A1). The orientation angle of each slot 13 is designed to allow a straight cutting utensil 400 (FIG. 4) to pass through the slot pairs 13A or 13B within the food receiving cavity 110.

Turning now to FIG. 4, a perspective view of the front side of an example of a slicing guide apparatus 100 according to various embodiments is depicted. In this example, a user's hand 200 is securing the apparatus 100 over a cutting board 300. The other hand 200 of the user is manipulating a cutting utensil 400 to cut a perishable food item 500 but other types of food or other items may be used with the apparatus 100 as well. In this example, the perishable food item 500 is placed into the interior food receiving cavity 110 of the apparatus 100 so that it is surrounded by the wall 14. The blade of the cutting utensil 400 passes through two opposite slots 13 and will cut the perishable food item 500 as it passes from the top of the slots 13 towards the base 11 of the apparatus 100. By placing the blade of the cutting utensil 400 in subsequent pairs of slots 13, the perishable food item 400 is reduced to bite-sized pieces.

The apparatus 100 may be made from durable materials such as hard plastics, metals, metal alloys, wood, hard rubbers, carbon fiber, or any other suitable materials including combinations of materials. Additionally, the apparatus may comprise one or more durable and slightly flexible materials such as soft plastics, silicone, soft rubbers, or any other suitable materials including combinations of materials.

In preferred embodiments, the cutting utensil 400 may comprise metal, metal alloys, a plastic or ceramic cutting blade that is able to easily cut through a perishable food item 500 located within the apparatus 100. In other embodiments, the blade of the cutting utensil 400 may be made from wood, hard rubbers, carbon fiber, or any other suitable materials including combinations of materials.

Also in preferred embodiments, indicia such as numerals, letters, symbols, and the like may be positioned on the wall 14 adjacent to one or more slots 13 to facilitate selection of one or more slots 13 through which the user desires to pass the blade of the cutting utensil 400 through. In other embodiments, the slots 13 may comprise various colors or shapes to facilitate selection of one or more slots 13 through which the user desires to pass the blade of the cutting utensil 400 through. In further embodiments, the wall 14 may comprise various colors or shapes to facilitate selection of one or more slots 13 through which the user desires to pass the blade of the cutting utensil 400 through.

One skilled in the art will recognize that while the slicing guide apparatuses and methods described are well suited for perishable food items such as lettuce, other types of perishable food items may be used including cauliflower, bread, cabbage, onions, meats, cheese, fruits, tomatoes, pineapples, potatoes, pastas, and any other cooked or uncooked perishable food item that may be cut with the blade of a cutting utensil 400.

Still referring to FIG. 4, an embodiment of an exemplary method of reducing the size of perishable food items 500, in this illustration a half head of lettuce, is depicted. First, core the head of iceberg lettuce—this step is the removal of the core. Set the cutting board onto the counter top where the lettuce will be processed. Locate the core of the lettuce (the knob/stem at the base of the lettuce head) and position it facing directly downward. Hold the head of lettuce approximately 6 inches above the cutting board and impact the lettuce firmly onto the cutting board, breaking the core away from the rest of the lettuce. Grip the core with your fingers and pull it out (separating any leaves from it that have not detached, as you remove it). It will come out in a somewhat cone-shaped form. An optional method of coring (at the user's discretion) would be to cut a cone-shaped core out with a knife. Discard the core, once it has been removed. In some embodiments, the method may comprise cutting a cored head of lettuce into quarters (this method will yield the least elongated pieces) in preparation for processing it in the apparatus 100. The head of lettuce is placed onto a cutting board 300, absent the presence of the slicing guide. A mark is sliced onto the top of the head of lettuce at its midpoint with the blade of a cutting utensil 400 (this will be the second slice to make, momentarily). While carefully holding the head of lettuce together with one hand (from above) firstly cut through the lettuce halfway between the right side and the midpoint of the lettuce, secondly cut through the midpoint of the lettuce, and thirdly cut halfway between the midpoint of the lettuce and the left side. This will yield a stack of two quarters making up the right half of the head of lettuce and a stack of two quarters making up the left half. Place the right half and left half stacks of lettuce quarters separately onto a plate (sliced-ends facing downwards), away from the cutting board 300.

In other embodiments, the method of cutting the head of lettuce, in preparation for processing it in the apparatus 100, is to simply cut it in-two (note that this method will yield significantly more elongated pieces of lettuce than results from a head of lettuce that has been cut into quarters). The head of lettuce is placed onto a cutting board 300, absent the presence of the slicing guide. Place the blade of a cutting utensil 400 above the head of lettuce at the midpoint and slice the lettuce into two equal halves. Place the two halves of lettuce onto a plate (sliced-ends facing downwards), away from the cutting board 300.

In this example, the method of slicing comprises; placing a slicing guide apparatus 100 onto a cutting board 300. Press two stacked quarters/one half of the head of lettuce into the interior of the apparatus 100, flat side down and all the way down until the lettuce rests firmly on the cutting board 300. Next, insert a blade of a cutting utensil 400 into two opposing slots 13, holding it upward and over the lettuce. Press the blade of the cutting utensil 400 downward into the lettuce and optionally perform back and forth slicing actions until the lettuce is sliced completely through. Remove the blade from the apparatus 100. Insert the knife into the next set of slots, and again, slice through the lettuce. Repeat prior steps until the last slicing action from this side has been completed. Reposition the apparatus 100 and cutting board 300 approximately ninety degrees counter clockwise and repeat the above inserting/slicing/removing process until the lettuce has been completely sliced-up into pieces. Remove/clean/package (or serve) the lettuce. Repeat the above steps on the other two stacked quarters/one half of the head of lettuce.

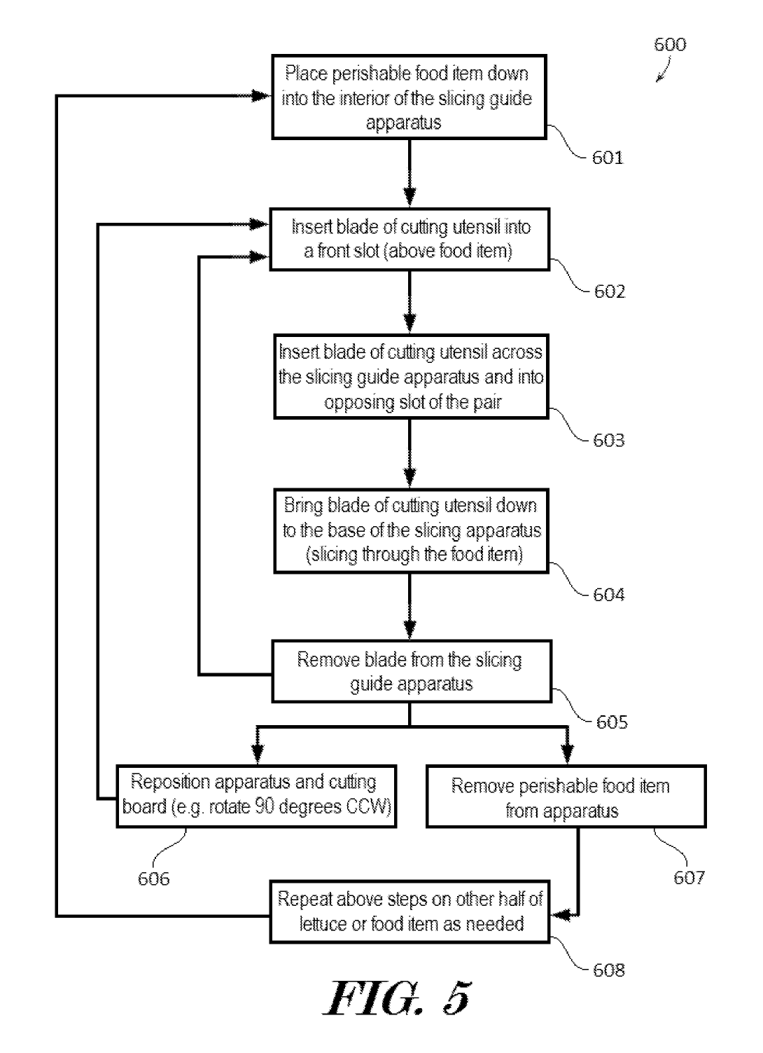

Turning now to FIG. 5, a flow chart 600 depicting an exemplary embodiment of a method of slicing and reducing the size of perishable food items 500 (FIG. 4) is shown. In this example, the method comprises a first step 601 of placing a perishable food item (or other item) 500 (FIG. 4) into the food receiving cavity 110 (FIG. 3B). The second step 602 comprises placing the blade of a cutting utensil 400 (FIG. 4) into a first front slot 13 (FIGS. 2-4). The third step 603 comprises placing the same blade of the cutting utensil 400 (FIG. 4) additionally into the slot on the opposite side of the guide 13 (FIGS. 3B-4) within the same slot pair (e.g. 13A1 to 13A1 on FIG. 3B) or opposite the first front slot 13. The fourth step 604 comprises moving the blade of the cutting utensil 400 (FIG. 4) down towards the base 11 (FIG. 1) of the apparatus 100 (FIGS. 1-4), slicing through the food. The fifth step 605 comprises removing the blade from the slicing guide apparatus' slots (FIGS. 1-4). Steps 602, 603, 604, and 605 are repeated as shown by proceeding from step 605 to step 602 and placing the cutting blade into additional slot pairs as needed until the food item has been entirely sliced from the front side. Next, the user may proceed by either repositioning the apparatus 100 (FIGS. 1-4) (step 606), along with its perishable food item 500 (FIG. 4) for further cutting which is accomplished by repeating steps 602, 603, 604, and 605 until the perishable food has been entirely sliced from this side or as desired by the user, or upon completing the desired number of and order of steps, a seventh step 607 is completed which comprises removing the perishable food item 500 (FIG. 4) from the apparatus 100 (FIGS. 1-4). Step 608 directs the user to repeat the prior steps to slice-up the other half of lettuce, or until a desired number and size of pieces are obtained.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A slicing guide apparatus, the apparatus comprising:
a. a food receiving cavity;
b. a side wall surrounding the food receiving cavity;
c. a first elongate vertical slot located within the side wall at a first location,
d. a second elongate vertical slot located within the sidewall at a second location opposite the first elongate vertical slot; and
wherein said first elongate vertical slot and said second elongate vertical slot are configured to receive a cutting utensil allowing the cutting utensil to pass through the apparatus.

2. The apparatus of claim 1 further comprising a first end that is substantially open and free to receive food items within the food receiving cavity.

3. The apparatus of claim 2, wherein the first and second elongate vertical slots extend substantially the entire height of the side wall.

4. The apparatus of claim 3, wherein the first and second elongate vertical slots have an open end which is not bounded by the side wall and allows the cutting utensil to pass freely into and out of the apparatus.

5. The apparatus of claim 4, wherein the side walls are rounded to form an apparatus of a cylindrical shape.

6. The apparatus of claim 2, further comprising plurality of elongate vertical slots extending through at least one end of the apparatus wherein the elongate vertical slots are configured to receive a cutting utensil allowing the cutting utensil to pass through the apparatus and a food item.

7. The apparatus of claim 6, wherein the plurality of elongate vertical slots are arranged in opposing pairs of elongate vertical slots with each opposing pair belonging to a set.

8. The apparatus of claim 7, wherein a first set is positioned perpendicular to a second set thereby forming a grid of cutting channels through the food receiving cavity.

9. The apparatus of claim 7, wherein each elongate vertical slot is configured with an orientation angle to align a straight cutting utensil up with the opposing elongate vertical slot of the pair.

10. The apparatus of claim 9, wherein the side walls are rounded to form an apparatus of a cylindrical shape.

11. A method of slicing food items, the method comprising;
a. placing a food item into the interior of a slicing guide apparatus;
b. inserting the blade of a cutting utensil into a first elongate vertical slot above the food item;
c. further passing the blade of a cutting utensil into a second elongate vertical slot opposite the first elongate vertical slot and above the food item;
d. passing the blade of the cutting utensil down through the first and second elongate vertical slots through the food item;
e. removing the blade of the cutting utensil from the apparatus; and
f. repeating the above steps as needed until the cutting utensil has cut the food item into a desired shape and size.

12. The method of claim 11 further comprising repositioning the apparatus and the food item and;
a. inserting the blade of a cutting utensil into a first elongate vertical slot above the food item;
b. further passing the blade of a cutting utensil into a second elongate vertical slot opposite the first elongate vertical slot and above the food item;
c. passing the blade of the cutting utensil down through the first and second elongate vertical slots through the food item;
d. removing the blade of the cutting utensil from the apparatus; and
e. repeating the above steps as needed until the cutting utensil has cut the food item into a desired shape and size.
